(19) United States
(12) Patent Application Publication
(10) Pub. No.: US 2017/0068988 A1
(43) Pub. Date: Mar. 9, 2017

(54) DEVICE INTEGRITY BASED ASSESSMENT OF INDICATION OF USER ACTION ASSOCIATED WITH AN ADVERTISEMENT

(71) Applicant: Sony Mobile Communications Inc., Tokyo (JP)

(72) Inventor: David Karlsson, Lund (SE)

(21) Appl. No.: 14/844,804

(22) Filed: Sep. 3, 2015

(51) Int. Cl. G06Q 30/02

(52) U.S. Cl. CPC G06Q 30/0248; G06Q 30/0246; G06Q 30/0277

(57) ABSTRACT

An advertisement management server provides an advertisement to a user device. Further, the advertisement management server receives, from the user device, an indication of a user action associated with the advertisement. The user action may for example correspond to selecting the advertisement via a user interface of the user device, e.g., by a click or similar selection method. Further, the advertisement management server obtains an integrity status of the user device from a device integrity server. Depending on the obtained integrity status of the user device the advertisement management server assesses the indication of the user action.

### FIELD OF THE INVENTION

The present invention relates to methods of assessing an indication of a user action associated with an advertisement and to corresponding devices and systems.

### BACKGROUND OF THE INVENTION

In internet-based advertising, it is known to pay publishers of advertisements, e.g., publishers of web pages, depending on an amount of user actions with respect to a certain advertisement. Such user action may correspond to viewing the advertisement or selecting the advertisement, e.g., by clicking the advertisement. Such payments may be managed by an entity referred to as advertisement broker. The payment may also depend on further information the advertisement publisher can provide, e.g., location, device information, or demographic information, because such information may allow for targeting advertisements to specific users or groups of users.

Since the payment of the publisher depends on the amount of indicated user actions, there is a risk of fraudulent attempts to generate indications of such user actions in an automated manner, e.g., by using computer programs which simulate clicks on advertisements. This is also referred to as “click fraud”. Accordingly, in order to ensure fair payment to publishers of advertisements, mechanisms are needed which facilitate deciding whether an indicated user action, such as a click on an advertisement, is a result of real user activity or rather associated with fraudulent mimicking of such user activity by a computer program.

### SUMMARY OF THE INVENTION

According to an embodiment of the invention, a method of managing advertisements is provided. According to the method, a first server, also referred to as advertisement management server, provides an advertisement to a user device. Further, the first server receives, from the user device, an indication of a user action associated with the advertisement. The user action may for example correspond to selecting the advertisement via a user interface of the user device, e.g., by a click or similar selection method. Further, the first server obtains an integrity status of the user device from a second server, also referred to as device integrity server. The integrity status may be based on one or more reports from the user device to the second server. Depending on the obtained integrity status of the user device the first server assesses the indication of the user action.

According to a further embodiment of the invention, a device is provided. The device comprises at least one interface to a user device and to a server. Further, the device comprises one or more processors. The one or more processors are configured to provide an advertisement via the at least one interface to the user device. Further, the one or more processors are configured to receive via the at least one interface an indication of a user action associated with the advertisement from the user device. Further, the one or more processors are configured to obtain via the at least one interface an integrity status of the user device from a device integrity server. The integrity status may be based on one or more reports from the user device to the device integrity server. Further, the one or more processors are configured to assess the indication of the user action depending on the obtained integrity status of the user device.

The one or more processors may be configured to perform steps of the above method as performed by the advertisement management server.

According to a further embodiment of the invention, a system is provided. The system comprises a first server, also referred to as advertisement management server, and a second server, also referred to a device integrity server. The first server is configured to provide an advertisement to a user device, to receive, from the user device, an indication of a user action associated with the advertisement, to obtain, from the second server, an integrity status of the user device, and to assess the indication of the user action depending on the obtained integrity status of the user device. The second server is configured to determine the integrity status of the user device based on one or more reports from the user device to the second server. According to an embodiment, the system may further comprise the user device, which is configured to send the one or more reports to the second server.

According to an embodiment of the above method, device or system, the integrity status of the user device is obtained from a database maintained by the device integrity server.

According to an embodiment of the above method, device or system, the one or more reports from the user device are verified by the device integrity server based on a device key of the user device.

According to an embodiment of the above method, device or system, the device key is stored in the user device by a manufacturer of the user device.

According to an embodiment of the above method, device or system, the device key is stored in a secured storage of the user device.

According to an embodiment of the above method, device or system, the one or more reports from the user device are signed by the device key.

According to an embodiment of the above method, device or system, the one or more reports are generated by a module of the user device which is configurable exclusively by a manufacturer of the user device.

According to an embodiment of the above method, device or system, the integrity status of the user device indicates a probability that the user device was manipulated.

The above and further embodiments of the invention will now be described in more detail with reference to the accompanying drawings.

### BRIEF DESCRIPTION OF THE DRAWINGS

FIG. 1 schematically illustrates a system for managing advertisements according to an embodiment of the invention.

FIG. 2 schematically illustrates an example of processes in which a click is assessed according to an embodiment of the invention.

FIG. 3 schematically illustrates a further example of processes in which a click is assessed according to an embodiment of the invention.

FIG. 4 shows a flowchart for illustrating a method according to an embodiment of the invention.

FIG. 5 schematically illustrates a processor based implementation of an advertisement management server according to an embodiment of the invention.

FIG. 6 schematically illustrates a processor based implementation of a device integrity server according to an embodiment of the invention.

### DETAILED DESCRIPTION OF EMBODIMENTS

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to management of internet-based advertisements, such as advertisements shown by an application running on a user device. Examples of such applications are browser applications, multimedia streaming client applications, messaging applications, or gaming applications. The advertisements are assumed to be provided to the user device through a network interface, e.g., a radio interface to a cellular network or other radio interface or a wire-based interface. A publisher of the application or a publisher of content shown by the application may get a reward depending on user actions associated with the advertisements.

In some of the following discussions, it will be assumed that such user action corresponds to a “click”. The click may involve that the user uses a computer mouse or similar pointing device to select the advertisement or an element of the advertisement, such as a button. However, it is to be understood that, depending on a user interface of the user device, also other user actions may be interpreted as a click, such as tapping on the advertisement on a touch-sensitive display of the user device. Further, the illustrated concepts may also be applied with respect to other kinds of user actions. Examples of such other kinds of user actions are viewing the advertisement, e.g., indicated in terms of a time period the advertisement was left to be visible in a significant part of the user interface, listening to the advertisement, e.g., indicated in terms of a time period the advertisement was left to be audible from an audio output of the user device, a mouse-over operation on the advertisement, closing the advertisement, or the like.

The illustrated concepts aim at facilitating assessment whether an indication of a user action associated with an advertisement results from real user activity or if such user activity is only mimicked by a computer program installed on the user device, probably without the user being aware of the presence of such computer program on the user device. For example, the computer program mimicking the user activity could be a computer virus or other kind of malware.

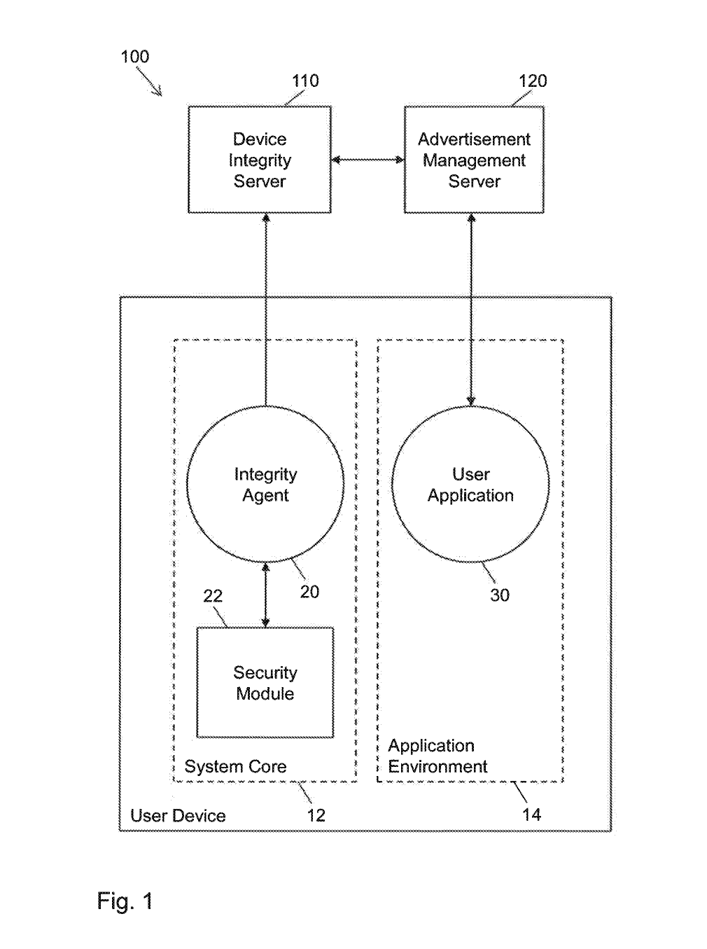

FIG. 1 schematically illustrates a system 100 which may be used for management of advertisements. As illustrated, the system includes a user device 10, a device integrity server 110, and an advertisement management server 120. In the example of FIG. 1, the user device 10 may be a smartphone, a tablet computer, a gaming device, or other kind of portable or stationary computer device.

As illustrated, the user device 10 is provided with an integrity agent 20 and a security module 22. The integrity agent 20 is configured to regularly send reports to the device integrity server 110. This may be accomplished in a protected environment. For example, the security module 22 may store a device key provided by the manufacturer of the user device 10, and the integrity agent 20 may utilize the device key for signing the reports sent to the device integrity server 110. The device key may be unique, i.e., differ from device keys used for other user device, and be stored in a secured way by the manufacturer in the user device 10, typically during the manufacturing process. For example, the security module 22 may store the device key using a technology referred to as “secure element”, provided by GlobalPlatform, Inc., or using a technology referred to as “TrustZone”, provided by ARM Ltd. The security module 22 may operate in such a way that the device key is destroyed if the system of the user device 10 is tampered with, e.g., if a rooting attempt is made. If the device key is provided to the user device 10 during the manufacturing process of the user device 10, the manufacturer of the user device 10 may also provide the device key to the device integrity server 110, e.g., through a secured interface of the device integrity server 110.

Further, the user device 10 is provided with a user application 30 which supports internet-based advertisements. The user application 30 may for example correspond to a browser application, a multimedia streaming client application, a messaging application, or a gaming applications. The advertisements are provided by the advertisement management server 120 to the user application 30. Accordingly, the user device 10 is equipped with one or more interfaces which allow for sending the reports generated by the integrity agent 20 to the device integrity server 110 and for communication of the user application 30 with the advertisement management server 120. Such interface(s) may for example be based on general IP

(Internet Protocol) connectivity of the user device 10. The reports provided by the to the device integrity server 110 may indicate a current public IP address of the user device 10, which may then be used for identifying the user device 10 in communication of the device integrity server 110 and the advertisement management server 120. The reports may be sent in a periodic manner and/or in response to one or more triggering events, such as allocation of a new public IP address.

As illustrated, the integrity agent 20 and the security module 22 may be implemented as part of a system core 12 of the user device 10, e.g., as part of an operating system or even as by dedicated hardware of the user device. The system core 12 of the user device 10 is typically defined and configured by the manufactured of the user device 10 and allows only limited modifications by a user of the user device 10 or any other party. As compared to that, the user application 30 may be implemented within an application environment 14 of the user device 10, which is open to installation of program code by the user or other parties.

In the illustrated concepts, the device integrity server 110 maintains a device integrity status of the user device 10. The device integrity status indicates a probability that the user device was manipulated, e.g., by installation of malicious program code or removal of software locks. The device integrity server 110 may determine the device integrity status on the basis of the reports provided by the integrity agent of the user device 10 to the device integrity server. The reports may for example indicate information which enables the device integrity server 110 to judge if attempts have been made to circumvent a security mechanism of the user device or to otherwise manipulate the user device in such a way that there is an increased risk of installation of malicious program code. The information in the reports may for example include a list of system processes of the user device 10, a memory layout of the user device 10, system properties of the user device 10, a fingerprint of file system files of the user device 10, or the like. The device integrity server 110 may in turn be provided with information which allows for evaluating such information. Such information may for example be provided by a manufacturer of the user device 10 and represent characteristics of the user device 10 in a state of delivery. The reports may then be evaluated by the device integrity server 110 with respect to a degree of deviation of the user device 10 from the delivery state. A low degree of deviation may be interpreted as a high device integrity, whereas a high degree of deviation may be interpreted as a low device integrity. In some scenarios, the device integrity server 110 may be hosted by the manufacturer of the user device 10. In such cases, the manufacturer of the user device 10 may utilize the device integrity server 110 as to provide a service which allows other parties to request the device integrity status, which can be based on various kinds of information, even on device characteristics which are not open to the public.

In typical scenarios, the device integrity server 110 can maintain the device integrity status for a plurality of user devices, e.g., in a database in which the public IP address and/or some other device identifier which is known to the advertisement management server 120 can be used as a key for finding the device integrity status of a particular user device.

Through the interface to the user device 10, the advertisement management server 120 may provide an advertisement to the user device 10 and subsequently receive an indication of a user action associated with this advertisement from the user device 10. For assessing whether the indication results from real user activity or if such user activity is only mimicked by a computer program installed on the user device 10, the advertisement management server 120 may obtain the current device integrity status of the user device from the device integrity server 110 and perform the assessment depending on the device integrity status. If the device integrity status corresponds to a high integrity, the advertisement management server 120 may decide that the indication is probably the result of a real user activity. On the other hand, if the device integrity status corresponds to a low integrity, the advertisement management server 120 may decide that the indication is probably the result of user activity mimicked by a computer program. Here, it is to be understood that the device integrity status may also be utilized in combination with other criteria, e.g., monitoring of characteristic traffic patterns generated by the user device 10.

Depending on the assessment of the indication, the advertisement management server 120 may then for example determine a reward for the publisher of the advertisement. The publisher may be a provider of the user application 30 or a provider of content shown by the user application 30. In some scenarios, also the manufacturer of the user device 10 may act as publisher of the advertisements and receive the reward.

In some scenarios, the reward may be weighted according to the device integrity status. Typically, the reward would be determined to increase with increasing integrity. For such scenarios, it may be beneficial to represent the device integrity status in terms of multiple different integrity levels or in terms of a numerical value indicating a degree of integrity, e.g., as a percentage ranging from 0% (corresponding to the lowest integrity) to 100% (corresponding to the highest integrity). In some cases, if the assessment reveals that it is almost certain that the indication of the user action is a result of user activity is only mimicked by a computer program, a reward may also be declined.

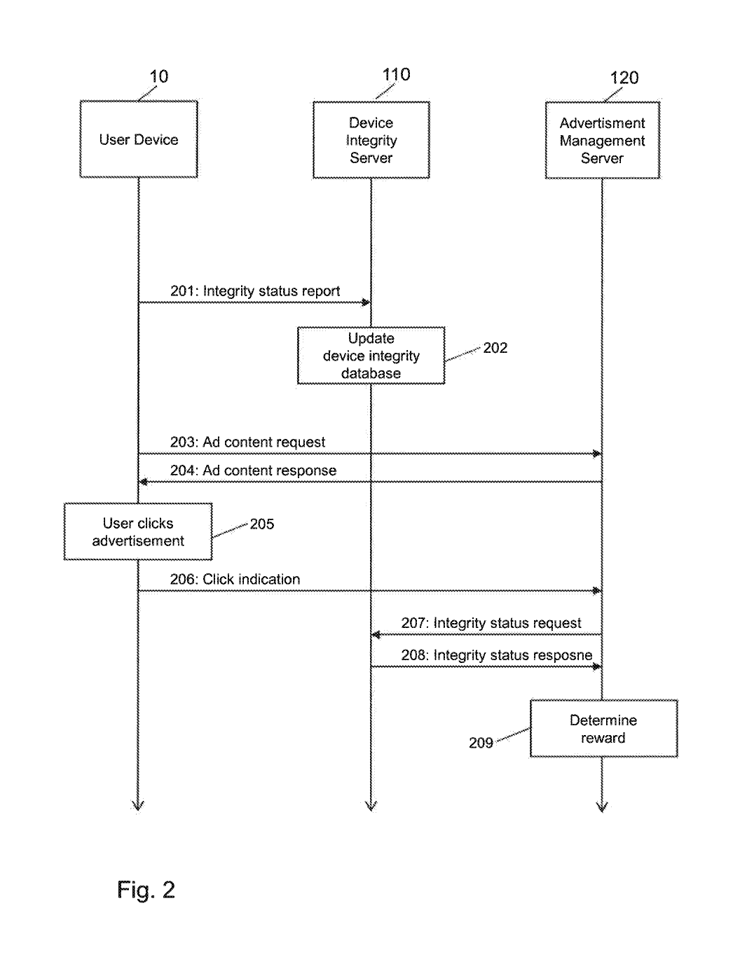

FIG. 2 shows an example of processes which are based on the above concepts. The processes of FIG. 2 involve the user device 10, the device integrity server 110, and the advertisement management server 120.

In the processes of FIG. 2, the user device 10 sends a report 201 to the device integrity server 110. Sending of the report 201 may be triggered by a periodic reporting schedule configured in the user device 10 or by a triggering event define for this purpose. Examples of such triggering event are assignment of a new public IP address to the user device 10, modification of system settings of the user device 10, or installation of a new application on the user device 10. The report 201 may for example be conveyed by one or more IP data packets, e.g., using HTTPS (Hypertext Transfer Protocol Secure) as secured transport mechanism. To prevent manipulation of the report 201, the report 201 is signed by the device key, so that the device integrity server 110 can verify the report 201 based on the device key. In addition to the information which enables the device integrity server 110 to determine the device integrity status, the report 201 also indicates the current public IP address of the user device 10. Further, the report 201 may include a timestamp corresponding to the time when the report 201 was generated by the user device 10. Such timestamp may be used by the device integrity server 110 to assign a weight to the information in the report 201 when determining the device integrity status. For example, older information may be assigned a lower weight than more recent information. Further, the report 201 may also include an identifier assigned to the device key. This identifier may be used by the device integrity server 110 to identify the correct device key to be applied when processing the signed report 201.

At 202, the device integrity server 110 updates the database with the newly determined device integrity status of the user device 10. As mentioned above, the device integrity status of the user device 10 may be stored in an entry of the database which is accessible by using the current public IP address of the user device 10 as a key.

The user device 10 then issues a request 203 for advertisement content (ad content request) towards the advertisement management server 120. This request 203 may for example correspond to a HTTP (Hypertext Transfer Protocol) request or HTTPS request. From the request 203, the advertisement management server 120 may also determine the current public IP address of the user device 10.

The advertisement management server 120 then responds to the request 203 by sending an advertisement content response (ad content response) 204 to the user device 10. The advertisement content response 204 may include textual content, image content, audio content, and/or video content of an advertisement. In some cases, also a script for automated functions of the advertisement may be included. Alternatively or in addition, the advertisement content response 204 may also include a reference to another server from which a part of such content can be retrieved. The advertisement content response 204 may for example be transmitted in a HTTP response or HTTPS response.

At 205, the user of the user device 10 clicks the advertisement, i.e., performs a user action as described above. The user device 10 indicates this user action to the advertisement management server 120, by sending a click indication 206 to the advertisement management server 120. The click indication 206 may be transmitted in a HTTP message or HTTPS message (request or response).

Upon receiving the click indication 206, the advertisement management server 120 issues an integrity status request 207 for the current integrity status of the user device 10 towards the device integrity server 110. The integrity status request 207 indicates the current public IP address of the user device 10, to be used by the device integrity server 110 as a key to identify the correct entry of the database, which stored the device integrity status for the user device 10. The integrity status request 207 may for example be transmitted in a HTTPS request.

The device integrity server 110 responds to the integrity status request by sending an integrity status response 208 to the advertisement management server 120. The integrity status response 208 indicates the device integrity status of the user device 10 as retrieved by the device integrity server 110 from the database. The integrity status response 208 may for example be transmitted in a HTTPS response. By using HTTPS for the communication between the device integrity server 110 and the advertisement management server 120, manipulation of the indicated device integrity status can be avoided.

At 209, the advertisement management server 120 determines a reward for the user action indicated by the click indication 206. In the scenario of FIG. 2, it is assumed that the device integrity status of the user device 10 as indicated by the integrity status response 208 is sufficient to consider the indicated user action as being a result of real user activity, and not user activity mimicked by a computer program. The advertisement management server 120 thus authorizes that a reward is granted to the publisher of the advertisement, e.g., a financial reward. A size of this reward may depend on the device integrity status indicated by the integrity status response 208. For example, if the device integrity status is indicated in terms of a percentage with 0% corresponding to the lowest integrity and 100% corresponding to the highest integrity, the reward could be calculated as being proportional to this percentage.

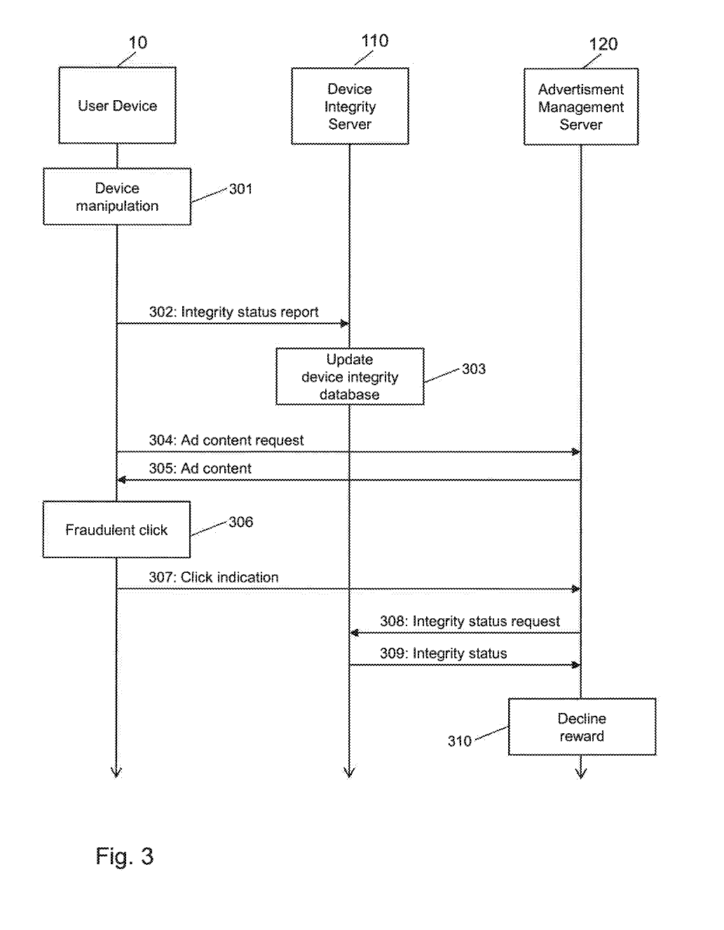

FIG. 3 shows a further example of processes which are based on the above concepts. The processes of FIG. 3 involve the user device 10, the device integrity server 110, and the advertisement management server 120.

As compared to the processes of FIG. 2, in the processes of FIG. 3 a device manipulation is assumed to occur at 301. The device manipulation may for example correspond to installation of malicious program code, e.g., a computer program which mimics user activity on advertisements, such as by mimicking clicks on advertisements.

After the manipulation at 301, the user device 10 sends a report 302 to the device integrity server 110. Sending of the report 201 may be triggered by a periodic reporting schedule configured in the user device 10 or by a triggering event define for this purpose. Examples of such triggering event are assignment of a new public IP address to the user device 10, modification of system settings of the user device 10, or installation of a new application on the user device 10. In the scenario of FIG. 3, sending of the report may also be triggered by the manipulation at 301, e.g., because the manipulation resulted in a change of system settings or involved installation of a new application. As in the example of FIG. 2, the report 302 may be conveyed by one or more IP data packets, e.g., using HTTPS as secured transport mechanism and be signed by the device key, so that the device integrity server 110 can verify the report 302 based on the device key. In addition to the information which enables the device integrity server 110 to determine the device integrity status, the report 302 also indicates the current public IP address of the user device 10. Further, the report 302 may include a timestamp corresponding to the time when the report 302 was generated by the user device 10. Such timestamp may be used by the device integrity server 110 to assign a weight to the information in the report 302 when determining the device integrity status. For example, older information may be assigned a lower weight than more recent information. Further, the report 302 may also include an identifier assigned to the device key. This identifier may be used by the device integrity server 110 to identify the correct device key to be applied when processing the signed report 302.

At 303, the device integrity server 110 updates the database with the newly determined device integrity status of the user device 10. As mentioned above, the device integrity status of the user device 10 may be stored in an entry of the database which is accessible by using the current public IP address of the user device 10 as a key. In view of the manipulation at 301, the device integrity status determined in the scenario of FIG. 3 corresponds to a lower integrity than in the scenario of FIG. 2.

The user device 10 then issues a request 304 for advertisement content (ad content request) towards the advertisement management server 120. This request 304 may for example correspond to a HTTP request or HTTPS request. From the request 304, the advertisement management server 120 may also determine the current public IP address of the user device 10.

The advertisement management server 120 then responds to the request 304 by sending an advertisement content response (ad content response) 305 to the user device 10. The advertisement content response 305 may include textual content, image content, audio content, and/or video content of an advertisement. In some cases, also a script for automated functions of the advertisement may be included. Alternatively or in addition, the advertisement content response 204 may also include a reference to another server from which a part of such content can be retrieved. The advertisement content response 305 may for example be transmitted in a HTTP response or HTTPS response.

At 306, a fraudulent click on the advertisement is generated at the user device 10, e.g., by a computer program installed by the manipulation at 301. The user device 10, which handles the fraudulent click in the same manner as a click resulting from real user activity, indicates the fraudulent click to the advertisement management server 120 by sending a click indication 307 to the advertisement management server 120. The click indication 307 may be transmitted in a HTTP message or HTTPS message (request or response).

Upon receiving the click indication 307, the advertisement management server 120 issues an integrity status request 308 for the current integrity status of the user device 10 towards the device integrity server 110. The integrity status request 308 indicates the current public IP address of the user device 10, to be used by the device integrity server 110 as a key to identify the correct entry of the database, which stores the device integrity status for the user device 10. The integrity status request 308 may for example be transmitted in a HTTPS request.

The device integrity server 110 responds to the integrity status request by sending an integrity status response 309 to the advertisement management server 120. The integrity status response 309 indicates the device integrity status of the user device 10 as retrieved by the device integrity server 110 from the database. The integrity status response 309 may for example be transmitted in a HTTPS response. By using HTTPS for the communication between the device integrity server 110 and the advertisement management server 120, manipulation of the indicated device integrity status can be avoided.

At 310, the advertisement management server 120 determines a reward for the user action indicated by the click indication 307. In the scenario of FIG. 3, it is assumed that the device integrity status of the user device 10 as indicated by the integrity status response 309 is not sufficient to consider the indicated user action as being a result of real user activity. Rather, the click indicated by the click indication 307 is considered by the advertisement management server 120 as being the result of user activity mimicked by a computer program. The advertisement management server 120 thus declines a reward For example, if the device integrity status is indicated in terms of a percentage with 0% corresponding to the lowest integrity and 100% corresponding to the highest integrity, the reward could be declined in response to the percentage being below a threshold.

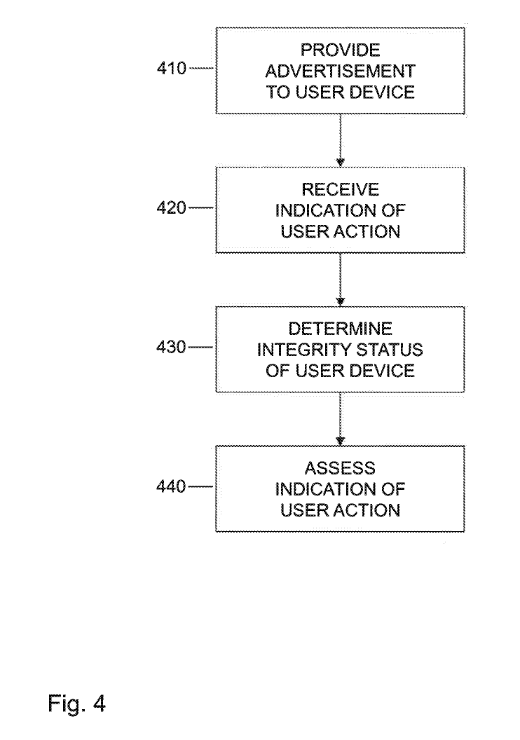

FIG. 4 shows a flowchart which illustrates a method of managing advertisements. The method is assumed to be implemented by a device which implements an advertisement management server, such as the advertisement management server 120, or a system including an advertisement management server, such as the advertisement management server 120, and a device integrity server, such as the device integrity server 110. Optionally such system may also include a user device, such as the user device 10. If a processor based implementation of any of these devices is utilized, at least a part of the steps of the method may be performed and/or controlled by one or more processors of the device.

At step 410, the advertisement management server provides an advertisement to a user device, e.g., the user device 10. This may be accomplished by sending textual content, image content, audio content, video content, and/or a script to the user device. In some scenarios, the advertisement management server may also provide the advertisement by providing a reference or link to such content to the user device.

At step 420, the advertisement management server receives an indication of a user action associated with the advertisement from the user device, e.g., an indication of a click or similar user action, such as the click indication 206 or the click indication 307.

At step 430, the advertisement management server obtains an integrity status of the user device 10 from a device integrity server, e.g., the device integrity server 110. The integrity status may for example be obtained from a database maintained by the device integrity server. The integrity status of the user device may indicate a probability that the user device was manipulated, e.g., in terms of information which enables the device integrity server to determine such probability. Obtaining the integrity status may for example involve sending a request to the device integrity server, such as the integrity status request 207 or 308, and receiving a response from the device integrity server, such as the integrity status response 208 or 309.

The integrity status of the user device may be based on one or more reports from the user device to the device integrity server, such as the reports 201 or 302. The reports may be verified by the device integrity server based on a device key of the user device. The device key may be stored in the user device by a manufacturer of the user device, e.g., in a secured storage of the user device, such as the above-mentioned security module 22. The device key may for example be used for signing the reports from the user device. The reports may be generated by a module of the user device which is configurable exclusively by a manufacturer of the user device.

At step 440, the advertisement management server assesses the indication of the user action depending on the obtained integrity status of the user device. This may involve deciding whether the indication is a result of real user activity or a result of user activity mimicked by a computer program running on the user device. At step 440, also a reward for the indication to a publisher of the advertisement may be determined. If the integrity status of the user device indicates insufficient integrity, such reward may be declined.

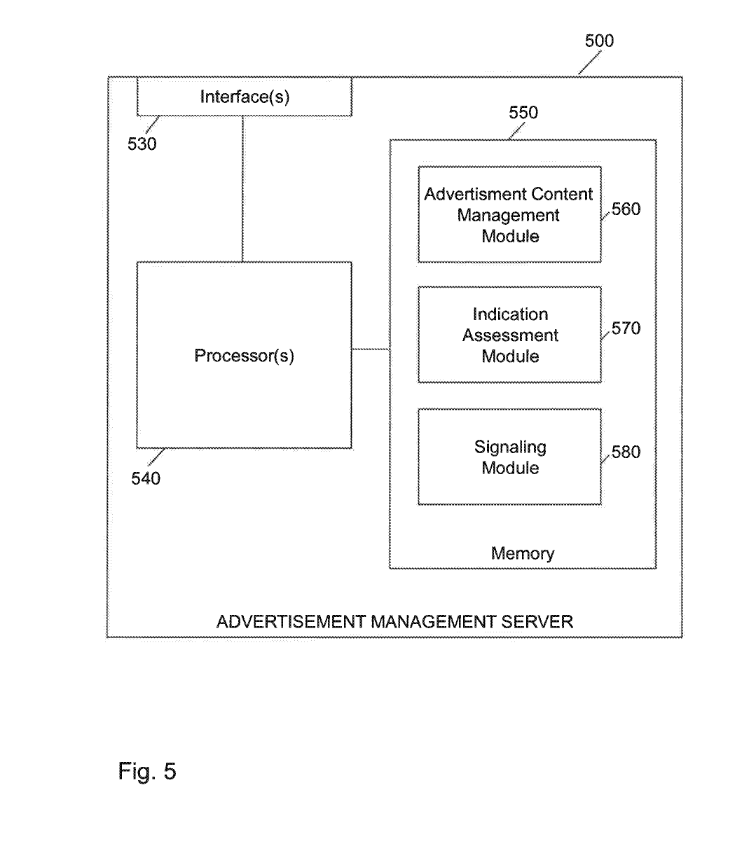

FIG. 5 shows a block diagram for schematically illustrating a processor based implementation of a device 500 which may be utilized for implementing an advertisement management server, such as the above-described advertisement management server 120.

As illustrated, the device 500 includes one or more interfaces 530. These one or more interfaces 530 may be used for communication with a user device, such as the above-described user device 10, and/or for communication with a device integrity server, such as the above-described device integrity server 110.

Further, the device 500 is provided with one or more processors 540 and a memory 550. The interface(s) 530, and the memory 550 are coupled to the processor(s) 540, e.g., using one or more internal bus systems of the device 500.

The memory 550 includes program code modules 560, 570, 580 with program code to be executed by the processor(s) 540. In the illustrated example, these program code modules include an advertisement content management module 560, an indication assessment module 570, and a signaling module 580.

The advertisement content management module 560 may implement the above-described functionalities of providing the advertisement to the user device, e.g., by selecting advertisement content in response to a request from the user device.

The indication assessment module 570 may implement the above-described functionalities of assessing the indication of a user action, e.g., by deciding whether it corresponds to a result of real user activity or to a result of user activity mimicked by a computer program.

The signaling module 580 may implement the above-described functionalities of communication with other devices, e.g., receiving advertisement content requests from a user device, responding to advertisement content requests from a user device, receiving indications of user actions associated with an advertisement, issuing integrity status requests, or receiving integrity status responses.

It is to be understood that the structures as illustrated in FIG. 5 are merely exemplary and that the device 500 may also include other elements which have not been illustrated, e.g., structures or program code modules for implementing known network functionalities or known functionalities for managing advertisements, e.g., functionalities for selecting advertisement content in a user specific manner.

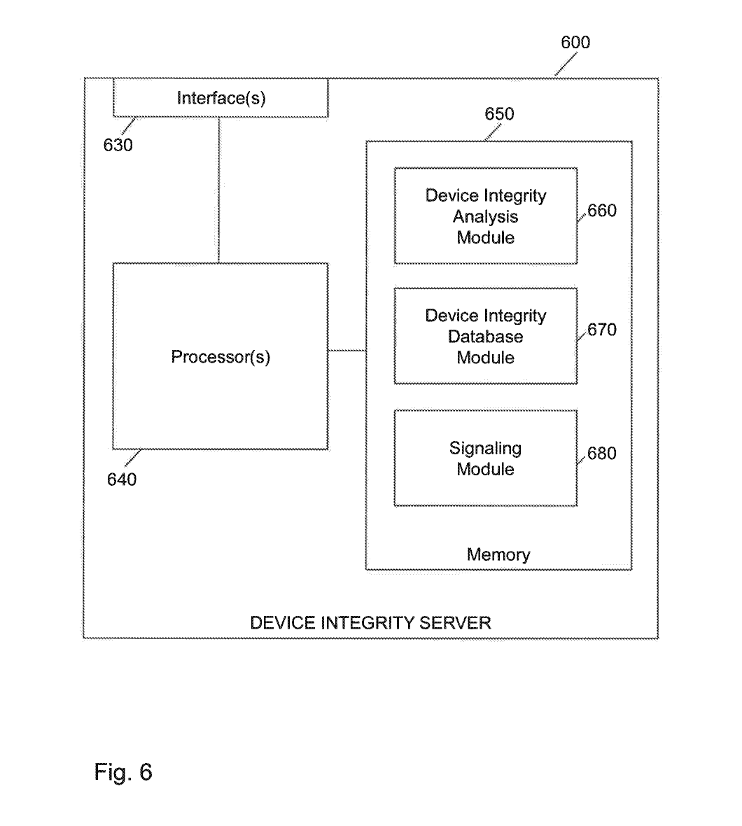

FIG. 6 shows a block diagram for schematically illustrating a processor based implementation of a device 600 which may be utilized for implementing a device integrity server, such as the above-described device integrity server 110.

As illustrated, the device 600 includes one or more interfaces 630. These one or more interfaces 630 may be used for communication with a user device, such as the above-described user device 10, and/or for communication with an advertisement management server, such as the above-described advertisement management server 120.

Further, the device 600 is provided with one or more processors 640 and a memory 650. The interface(s) 630, and the memory 650 are coupled to the processor(s) 640, e.g., using one or more internal bus systems of the device 600.

The memory 650 includes program code modules 660, 670, 680 with program code to be executed by the processor(s) 640. In the illustrated example, these program code modules include an integrity analysis module 660, an integrity database module 670, and a signaling module 680.

The integrity analysis module 660 may implement the above-described functionalities of determining the device integrity status based on the report(s) from the user device.

The integrity database module 670 may implement the above-described functionalities of storing the determined device integrity status and making the stored device integrity status available for responding to a later integrity status request from the advertisement management server.

The signaling module 680 may implement the above-described functionalities of communication with other devices, e.g., receiving reports from a user device, receiving integrity status requests, or sending integrity status responses.

It is to be understood that the structures as illustrated in FIG. 6 are merely exemplary and that the device 600 may also include other elements which have not been illustrated, e.g., structures or program code modules for implementing known network or database functionalities.

As can be seen, the concepts as explained above allow for efficiently assessing indications of user actions associated with advertisements. In particular, an advertisement management server may utilize the current integrity status of the user device to achieve a more reliable assessment whether the indication is the result of real user activity or the result of user activity mimicked by a computer program.

It is to be understood that the concepts as explained above are susceptible to various modifications. For example, the concepts could be applied in connection with various kinds of advertisements, e.g., text based, image based, audio based, video based, or even advertisements automated by a script to be executed by the user device. Further, the advertisements may be shown by various kinds of applications running on the user device. Still further, the concepts may be applied in connection with various kinds of user actions associated with advertisements.

1. A method of managing advertisements, the method comprising:
a first server providing an advertisement to a user device;
the first server receiving, from the user device, an indication of a user action associated with the advertisement;
the first server obtaining, from a second server, an integrity status of the user device; and
the first server assessing the indication of the user action depending on the obtained integrity status of the user device.

2. The method according to claim 1,
wherein the integrity status of the user device is obtained from a database maintained by the second server.

3. The method according to claim 1,
wherein the integrity status of the user device is based on one or more reports from the user device to the second server.

4. The method according to claim 3,
wherein said one or more reports from the user device are verified by the second server based on a device key of the user device.

5. The method according to claim 4,
wherein the device key is stored in the user device by a manufacture of the user device.

6. The method according to claim 4,
wherein the device key is stored in a secured storage of the user device.

7. The method according to claim 4,
wherein said one or more reports are signed by the device key.

8. The method according to claim 4,
wherein said one or more reports are generated by a module of the user device which is configurable exclusively by a manufacturer of the user device.

9. The method according to claim 1,
wherein the integrity status of the user device indicates a probability that the user device was manipulated.

10. A device, comprising:
at least one interface to a user device and to a server; and
one or more processors configured to:
via the at least one interface, provide an advertisement to the user device;
via the at least one interface, receive an indication of a user action associated with the advertisement from the user device;
via the at least one interface, obtain an integrity status of the user device from a device integrity server; and
assess the indication of the user action depending on the obtained integrity status of the user device.

11. The device according to claim 10,
wherein the integrity status of the user device is obtained from a database maintained by the device integrity server.

12. The device according to claim 10,
wherein the integrity status of the user device is based on one or more reports from the user device to the device integrity server.

13. The device according to claim 12,
wherein said one or more reports from the user device is verified by the device integrity server based on a device key of the user device.

14. The device according to claim 13,
wherein the device key is stored in the user device by a manufacture of the user device.

15. The device according to claim 13,
wherein the device key is stored in a secured storage of the user device.

16. The device according to claim 13,
wherein said one or more reports are signed by the device key.

17. The device according to claim 13,
wherein said one or more reports are generated by a module of the user device which is configurable exclusively by a manufacturer of the user device.

18. The device according to claim 10,
wherein the integrity status of the user device indicates a probability that the user device was manipulated.

19. A system, comprising:
a first server; and
a second server,
wherein the first server is configured to:
provide an advertisement to a user device;
receive, from the user device, an indication of a user action associated with the advertisement;
obtain, from the second server, an integrity status of the user device; and
assess the indication of the user action depending on the obtained integrity status of the user device,
wherein the second server is configured to determine the integrity status of the user device based on one or more reports from the user device to the second server.

20. The system according to claim 19,
wherein the system further comprises the user device, which is configured to send said one or more reports to the second server.
